(19) United States
(12) Patent Application Publication
(10) Pub. No.: US 2022/0070323 A1
(43) Pub. Date: Mar. 3, 2022

(54) IMAGE PROCESSING APPARATUS AND IMAGE PROCESSING METHOD

(71) Applicant: TOSHIBA TEC KABUSHIKI KAISHA, Tokyo (JP)

(72) Inventor: Satoshi TOKUDA, Mishima Shizuoka (JP)

(73) Assignee: TOSHIBA TEC KABUSHIKI KAISHA, Tokyo (JP)

(21) Appl. No.: 17/307,046

(22) Filed: May 4, 2021

(30) Foreign Application Priority Data
Sep. 2, 2020 (JP) 2020-147488

(51) Int. Cl. H04N 1/00

(52) U.S. Cl. CPC H04N 1/00766; H04N 1/00737; H04N 1/00331

(57) ABSTRACT

An image processing apparatus including a confirmation unit, a recognition unit, and a generation unit. The confirmation unit is configured to confirm that a predetermined element image is included at a predetermined position in each of a plurality of pages of read images. The recognition unit recognizes characters displayed in a recognition region determined relative to a region where the element image is formed. The generation unit is configured to generate a data file as a single file based on a recognition result of a page by the recognition unit, the page having a predetermined relationship with a page of the read image that is confirmed to include the element image by the confirmation unit.

### CROSS-REFERENCE TO RELATED APPLICATION

This application is based upon and claims the benefit of priority from Japanese Patent Application No. 2020-147488, filed on Sep. 2, 2020, the entire contents of which are incorporated herein by reference.

### FIELD

Embodiments described herein relate to an image processing apparatus and an image processing method.

### BACKGROUND

For example, as a function of a multi-function peripheral, a character recognition function of recognizing characters in a document through image processing on an image read from the document is known. Further, a file splitting function of splitting the result or character recognition into a plurality of data files is known. When this file splitting function is executed on a document that is readable through a barcode such as a document management code, using a configuration in which the barcode is included in a top page, a data file is generated by splitting the result of character recognition such that the first page is a document of which a barcode can be detected from a read image.

However, the above-described file splitting function cannot be used for a document where a barcode is not included in a top page.

Under these circumstances, it is desired to more easily use a function of splitting the result of character recognition to generate a plurality of data files.

### DESCRIPTION OF THE DRAWINGS

FIG. 1 is a block diagram illustrating a main circuit configuration of a MFP according to at least one embodiment;

FIG. 2 is a flowchart illustrating a zone OCR process;

FIG. 3 is a flowchart illustrating the zone OCR process;

FIG. 4 is a flowchart illustrating the zone OCR process;

FIG. 5 is a flowchart illustrating the zone OCR process;

FIG. 6 is a diagram illustrating an example of a structure of a recognition setting table;

FIG. 7 is a diagram illustrating an example of a structure of an anchor setting table; and

FIG. 8 is a diagram illustrating a state of file splitting.

### DETAILED DESCRIPTION

At least one embodiment provides an image processing apparatus and an image processing method in which a function of splitting the result of character recognition to generate a plurality of data files can be more easily used.

In general, according to at least one embodiment, there is provided an image processing apparatus including a recognition unit (processor), a confirmation unit (processor), a control unit (controller), and a generation unit (processor). The recognition unit is configured to recognize characters displayed on an image. The confirmation unit is configured to confirm that a predetermined element image is included in each of a plurality of pages of read images. The control unit is configured to control the recognition unit to recognize characters displayed in a recognition region determined relative to a region where the element image is formed. The generation unit is configured to generate a data file as a single file based on a recognition result of a page by the recognition unit, the page having a predetermined relationship with a page of the read image that is confirmed to include the element image by the confirmation unit.

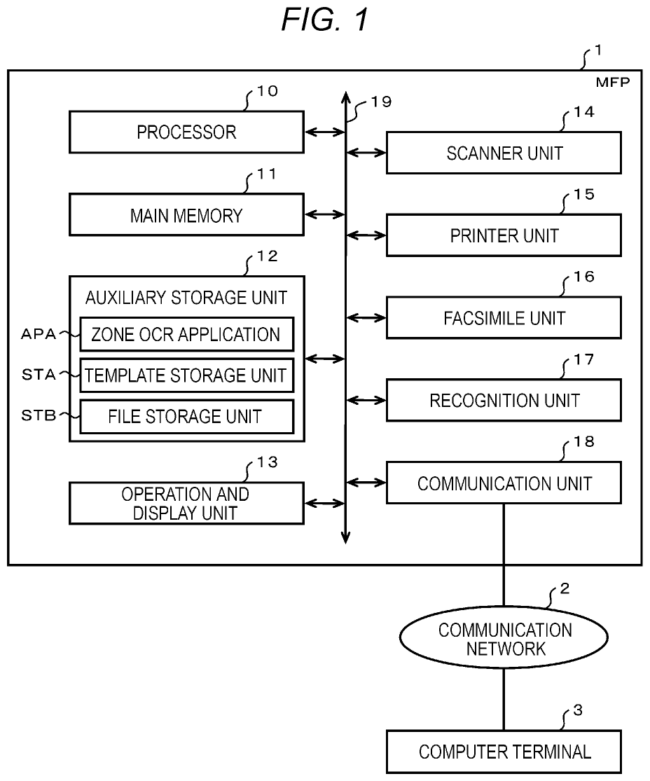

Hereinafter, an example of at least one embodiment will be described using the drawings. In at least one embodiment, a multi-function peripheral (MFP) having a function as an image processing apparatus will be described as an example. FIG. 1 is a block diagram illustrating a main circuit configuration of a MFP 1 according to the embodiment.

The MFP 1 includes a processor 10, a main memory 11, an auxiliary storage unit 12, an operation and display unit 13, a scanner unit 14, a printer unit 15, a facsimile unit 16, a recognition unit 17, a communication unit 18, and a transmission line 19. The processor 10, the main memory 11, the auxiliary storage unit 12, the operation and display unit 13, the scanner unit 14, the printer unit 15, the facsimile unit 16, the recognition unit 17, and the communication unit 18 are connected via the transmission line 19.

The processor 10, the main memory 11, and the auxiliary storage unit 12 are connected via the transmission line 19 such that a computer that executes information processing for controlling the MFP 1 is configured.

The processor 10 corresponds to a central part of the computer. The processor 10 executes information processing for controlling the respective units to implement various functions as the MFP 1 in accordance with an information processing program such as an operating system or an application program.

The main memory 11 corresponds to a main memory part of the computer. The main memory 11 includes a nonvolatile memory area and a volatile memory area. The main memory 11 stores the above-described information processing program in the nonvolatile memory area. In addition, the main memory 11 may store data required for the processor 10 to execute processing for controlling the respective units in the non-volatile or volatile memory area. The main memory 11 may use the volatile memory area as a work area where data is appropriately rewritten by the processor 10.

The auxiliary storage unit 12 corresponds to an auxiliary storage part of the above-described computer. As the auxiliary storage unit 12, for example, an electric erasable programmable read-only memory (EEPROM), a hard disk drive (HDD), a solid state drive (SSD), or other various peripheral storage devices can be used. The auxiliary storage unit 12 stores data used for the processor 10 to execute various processes and data generated during a process of the processor 10. The auxiliary storage unit 12 may also store the above-described information processing program. In the embodiment, the auxiliary storage unit 12 stores a zone OCR application APA that is one information processing program. The zone OCR application APA is an application program in which information processing for a zone optical character recognition (OCR) function described below is described. A storage area of the auxiliary storage unit 12 is used as a template storage unit STA and a file storage unit STB. The template storage unit STA stores a template file representing a setting for the zone OCR function. The file storage unit STB stores a data file generated by the zone OCR function.

The operation and display unit 13 receives an input from a user and displays various information to present the information to the user. The operation and display unit 13 may appropriately include various operation devices and display devices such as a touch panel, a keyboard, a key switch, an LED lamp, or a liquid crystal display panel.

The scanner unit 14 reads a document and generates image data of an image shown on the document.

The printer unit 15 prints the image represented by the image data on recording paper. The printer unit 15 includes a well-known printer device such as an electrophotographic image forming unit.

The facsimile unit 16 executes various well-known processing for executing image communication according to facsimile standards via communication network (not illustrated) such as a public switched telephone network (PSTN).

The recognition unit 17 recognizes characters displayed on the image represented by the image data through image processing on the image data generated by the scanner unit 14. The image processing that is executed by the recognition unit may be, for example, well-known processing. The recognition unit 17 is an example of the recognition unit.

The communication unit 18 executes communication processing for data communication via a communication network 2. As the communication unit 18, an existing communication device such as a local area network (LAN) can be used.

As the communication network 2, the Internet, a virtual private network (VPN), a LAN, a public communication network, a mobile communication network, and the like can be used singly or can be used appropriately in combination. As the communication network 2, for example, a LAN is used.

A computer terminal 3 is an information processing apparatus having a function of data communication via the communication network 2. The computer terminal 3 is operated by a user who uses the zone OCR function.

As the hardware of the MFP 1, for example, an existing MFP can be used as it is. The zone OCR application APA may be stored in the auxiliary storage unit 12 during the transfer of the hardware of the MFP 1 or may be transferred separately from the hardware. In the latter case, the zone OCR application APA is transferred via a network or a removable recording medium such as a magnetic disk, a magneto-optic disk, an optical disk, or a semiconductor memory in which the information processing program is recorded. In this case, the zone OCR application APA is provided as an option program or a version-up program and is newly written into the main memory 11 or the auxiliary storage unit 12 or is rewritten with the same type of another information processing program that is previously stored in the main memory 11 or the auxiliary storage unit 12.

Next, an operation of the MFP 1 configured as described above will be described. The content of the following processing is merely exemplary and, for example, change in the order of a part of the processing, omission of a part of the processing, or addition of another processing can be appropriately made.

The processor 10 in the MFP 1 controls the respective units of the MFP 1 so as to implement a print function, a copying function, a scanning function, a facsimile function, and the like as in the same type of an existing MFP. The description of the information processing for the control will not be made. Hereinafter, the characteristic zone OCR function of at least one embodiment will be described in detail.

For example, in a case where the start-up of the zone OCR function is instructed through, for example, a predetermined operation in the operation and display unit 13, the processor 10 starts information processing (hereinafter, referred to as “zone OCR process”) based on the zone OCR application APA.

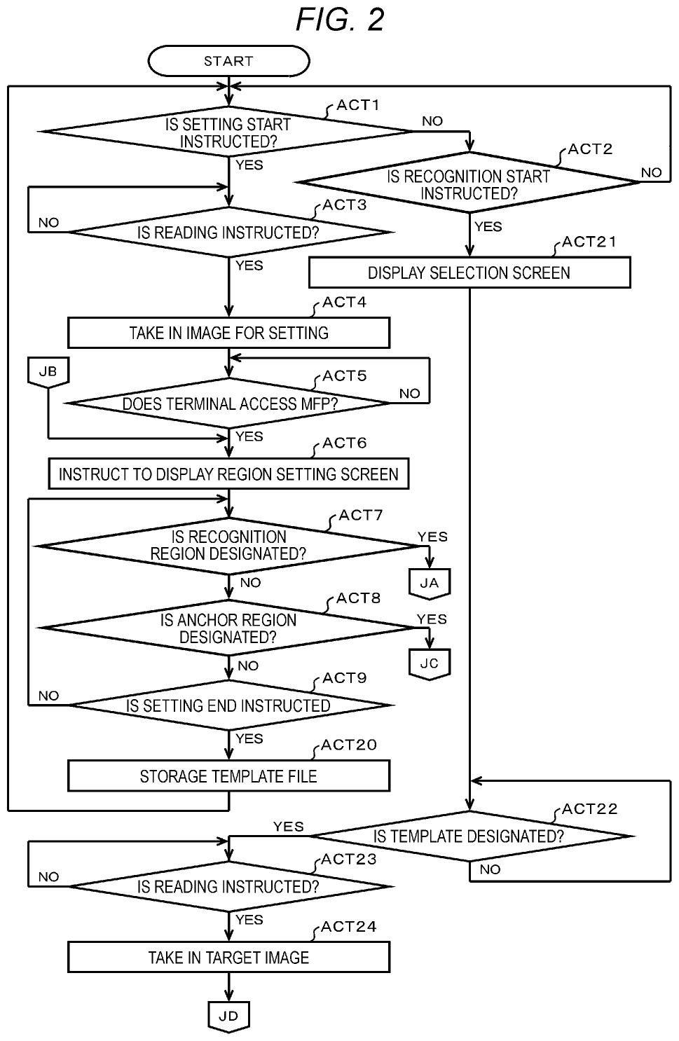

FIGS. 2, 3, 4, and 5 are flowcharts illustrating the zone OCR process.

In ACT 1 in FIG. 2, the processor 10 checks whether or not the setting start is instructed. When the instruction cannot be checked, the processor 10 determines NO and proceeds to ACT 2.

In ACT 2, the processor 10 checks whether or not the recognition start is instructed. When the instruction cannot be checked, the processor 10 determines NO and returns to ACT 1.

This way, in ACT 1 and ACT 2, the processor 10 waits for the instruction of the setting start or the recognition start.

When the user wants to register a new setting relating to the zone OCR function, the user instructs the setting start through, for example, a predetermined operation in the operation and display unit 13. In accordance with the instruction, the processor 10 determines YES in ACT 1 and proceeds to ACT 3.

In ACT 3, the processor 10 waits for an instruction to read a document.

After setting a document used for setting on the scanner unit 14, the user instructs reading of the document through, for example, a predetermined operation in the operation and display unit 13. In accordance with the instruction, the processor 10 determines YES in ACT 3 and proceeds to ACT 4.

In ACT 4, the processor 10 takes in an image for setting. The processor 10 causes, for example, the scanner unit 14 to read a document and stores the obtained image in the main memory 11 or the auxiliary storage unit 12 as the image for setting.

In ACT 5, the processor 10 waits for access from the computer terminal 3 via the communication network 2.

The user operates the computer terminal 3 to access the MFP 1 via the communication network 2. Using a general-purpose web browser, the computer terminal 3 accesses the MFP 1 based on an address assigned to the MFP 1 by the communication network 2. In this case, the computer terminal 3 may access the MFP 1 using a dedicated application for operating the MFP 1.

When computer terminal 3 accesses the MFP 1, the processor 10 determines YES in ACT 5 and proceeds to ACT 6. After authenticating the user who instructs to read the document in ACT 3 and authenticating the user who operates the computer terminal 3, the processor 10 may determine YES in ACT 5 only when both the users match each other.

In ACT 6, the processor 10 instructs the computer terminal 3 to display a region setting screen. The region setting screen includes the image for setting taken in ACT 4 and is an image for receiving a designation of a given region in the image for setting. The processor 10 transmits data of a web page to the computer terminal 3, the data representing the region setting screen and including a command defined to notify the designated region to the MFP 1. In the following description, the processor 10 instructs the computer terminal 3 to display various screens by transmitting data of web pages as described above.

In ACT 7, the processor 10 checks whether or not the recognition region is designated. When the designation cannot be checked, the processor 10 determines NO and proceeds to ACT 8.

In ACT 8, the processor 10 checks whether or not an anchor region is designated. When the designation cannot be checked, the processor 10 determines NO and proceeds to ACT 9.

In ACT 9, the processor 10 checks whether or not the setting end is instructed. When the instruction cannot be checked, the processor 10 determines NO and returns to ACT 7.

This way, in ACT 7 to ACT 9, the processor 10 waits for the designation of the recognition region or the anchor region or waits for the instruction of the setting end.

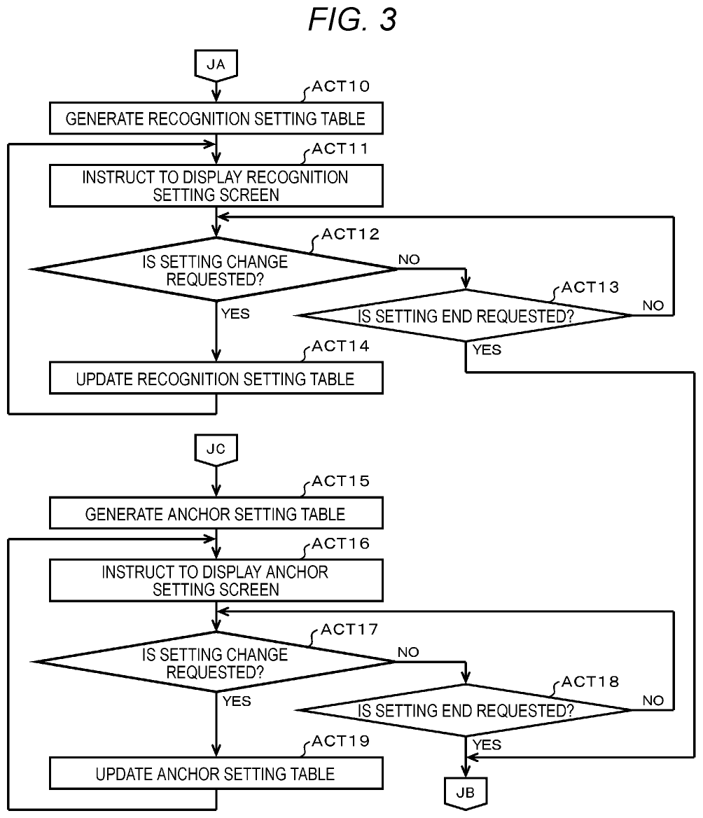

The computer terminal 3 displays the region setting screen in accordance with the instruction from the MFP 1. The user designates a region as a target for character recognition as the recognition region through a predetermined operation on the region setting screen in the computer terminal 3. As a result, the computer terminal 3 notifies coordinates representing a position of the recognition region based on a coordinate system that is determined in the image for setting and notifies the designation of the recognition region to the MFP 1. Accordingly, the processor 10 determines YES in ACT 7 and proceeds to ACT 10 in FIG. 3.

In ACT 10, the processor 10 generates a recognition setting table correlating to the present designated recognition region. The recognition setting table is a data table representing a setting for each of predetermined setting items regarding the correlated recognition region.

FIG. 6 is a diagram illustrating an example of a structure of a recognition setting table TAA.

The recognition setting table TAA includes fields FAA, FAB, FAC, FAD and FAE. In the field FAA, a region code as an identifier for distinguishing the correlated recognition region from another recognition region is set. In the field FAB, coordinates of the correlated recognition region are set. In the field FAC, a region name assigned to the correlated recognition region is set. In the field FAD, the type of a recognition target in the correlated recognition region is set. In the field FAE, a setting relating to the use of the recognition result in the correlated recognition region is set.

The processor 10 determines, as a region code of the present designated recognition region, a code different from a region code assigned to another recognition region that is already set, for example, in accordance with a predetermined rule, and sets the determined region code to the field FAA. The processor 10 sets, for example, coordinates notified from the computer terminal 3 to the field FAB. The processor 10 sets the determined region name to the field FAC, for example, in accordance with a predetermined rule. The processor 10 sets, for example, a type determined as a default among options of types of recognition targets to the field FAD. The options of the types of the recognition targets are, for example, “texts” and “barcodes”. The processor 10 sets, for example, a setting determined as a default among options of settings relating to the use of the recognition result to the field FAE. The options of the settings relating to the use of the recognition result are, for example, “Make Folder Name”, “Make File Name”, and “Do not Use”. The various rules and the various defaults may be freely set by, for example, a designer of the MFP 1, a manager of the MFP 1, a user, or the like.

In ACT 11 in FIG. 3, the processor 10 instructs the computer terminal 3 to display a recognition setting screen. The recognition setting screen is a screen for representing current settings relating to the recognition region in accordance with the recognition setting table TAA and for receiving an instruction to change settings for some setting items.

The computer terminal 3 displays the recognition setting screen in accordance with the instruction from the MFP 1. The user checks the current settings by visually inspecting the recognition setting screen. The user instructs to change settings relating to some setting items through a predetermined operation on the recognition setting screen in the computer terminal 3. For example, the user instructs to change the region name to a name determined by the user. As a result, the computer terminal 3 notifies the target items to be changed and changed settings to the MFP 1 and requests the MFP for setting change.

In ACT 12, the processor 10 checks whether or not the change of the settings relating to the recognition region is requested. When the request cannot be checked, the processor 10 determines NO and proceeds to ACT 13.

In ACT 13, the processor 10 checks whether or not the setting end relating to the recognition region is requested. When the request cannot be checked, the processor 10 determines NO and returns to ACT 12.

Thus, in ACT 12 and ACT 13, the processor 10 waits for the change request or the end request.

When the setting change is requested from the computer terminal 3 as described above, the processor 10 determines YES in ACT 12 and proceeds to ACT 14.

In ACT 14, the processor 10 updates the recognition setting table TAA such that the notification in the change request is reflected. For example, when the change of the region name is instructed as described above, the processor 10 rewrites the field FAC with the designated region name. Next, the processor 10 returns to ACT 11 and repeats the subsequent processes as described above.

When it is not necessary to change the settings relating to the recognition region, the user instructs the setting end through a predetermined operation on the recognition setting screen in the computer terminal 3. As a result, the computer terminal 3 requests the MFP 1 for the setting end. The processor 10 determines YES in ACT 13 in response to the request and returns to ACT 6 in FIG. 2.

When a new recognition region is designated after the processor 10 returns to ACT 6 from ACT 13, the processor 10 proceeds to ACT 10 in FIG. 3 from ACT 7 as described above. The processor 10 maintains the recognition setting table TAA generated thus far as it is and generates a new recognition setting table TAA. ACT 11 and ACT 14 are executed on the new recognition setting table TAA generated herein as a target. That is, the processor 10 receives settings relating to a plurality of recognition regions and generates recognition setting tables TAA corresponding to the recognition regions, respectively. When the recognition setting table TAA is previously present, the processor 10 may generate a new recognition setting table TAA instead of the previous recognition setting table TAA. Alternatively, the processor 10 may rewrite the field FAB of the previously present recognition setting table TAA with new designated coordinates. In addition, after returning to ACT 6 from ACT 13, the processor 10 may disallow the designation of a new recognition region.

When the user wants to use an anchor function, the user designates, as an anchor region, a region including an image to be used as an anchor through a predetermined operation on the region setting screen in the computer terminal 3. As a result, the computer terminal 3 notifies coordinates representing a position of the anchor region based on a coordinate system that is determined in the image for setting and notifies the designation of the anchor region to the MFP 1. Accordingly, the processor 10 determines YES in ACT 8 and proceeds to ACT 15 in FIG. 3. The image to be used as an anchor may be freely determined by the user. When a splitting function described below is used, an image shown in the first pages of a plurality of documents is used as an anchor. The image to be used as the anchor is, for example, a company logo.

In ACT 15, the processor 10 generates an anchor setting table correlating to the present designated anchor region. The anchor setting table is a data table representing a setting for each of predetermined setting items regarding the correlated anchor region.

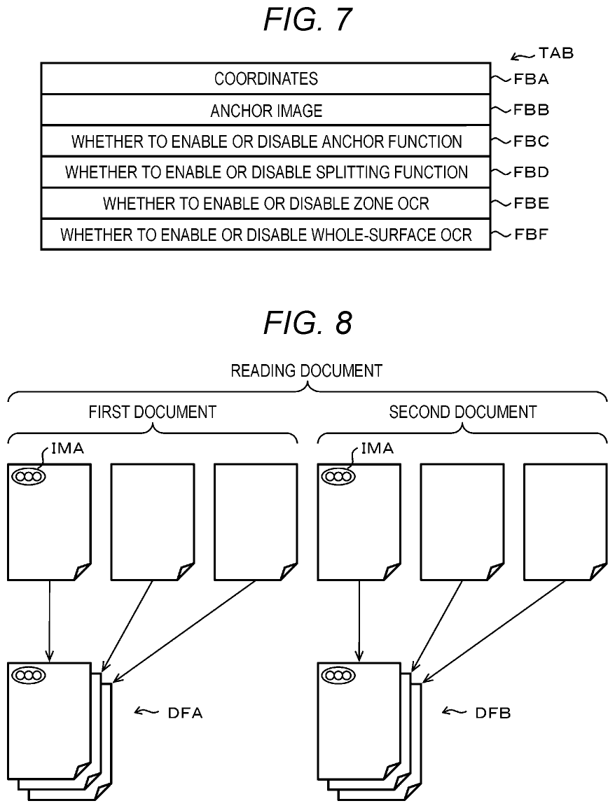

FIG. 7 is a diagram illustrating an example of a structure of an anchor setting table TAB.

The anchor setting table TAB includes fields FBA, FBB, FBC, FBD, FBE, and FBF. In the field FAA, coordinates of the correlated anchor region are set. In the field FBB, image data of an image (hereinafter, referred to as “anchor image”) shown in the correlated anchor region is set. In the field FBC, whether to enable or disable the anchor function for the correlated anchor region is set. In the field FBD, whether to enable or disable the splitting function for the correlated anchor region is set. In the field FBE, whether to enable or disable the zone OCR for the correlated anchor region is set. In the field FBF, whether to enable or disable whole-surface OCR for the correlated anchor region is set. The image data of the anchor image may be stored in a region outside the anchor setting table TAB. In this case, a path of the image data is set in the field FBB.

The processor 10 sets, for example, coordinates notified from the computer terminal 3 to the field FAA. The processor 10 cuts, for example, an image including the correlated anchor region from the image for setting, and sets image data representing the image to the field FBB. The processor 10 sets, for example, a setting that is determined as a default for each of the fields FBC and FBF among “Enable” and “Disable” to the corresponding field. The defaults of the respective items may be freely set by, for example, a designer of the MFP 1, a manager of the MFP 1, a user, or the like.

In ACT 16 in FIG. 3, the processor 10 instructs the computer terminal 3 to display an anchor setting screen. The anchor setting screen is a screen for representing current settings relating to the anchor region in accordance with the anchor setting table TAB and for receiving an instruction to change settings for some setting items.

The computer terminal 3 displays the anchor setting screen in accordance with the instruction from the MFP 1. The user checks the current settings by visually inspecting the anchor setting screen. The user instructs to change settings relating to some setting items through a predetermined operation on the anchor setting screen in the computer terminal 3. For example, when the user wants to change the setting for whether or not to enable or disable the splitting function from the default, the user instructs the setting change. As a result, the computer terminal 3 notifies the target items to be changed and changed settings to the MFP 1 and requests the MFP 1 for setting change.

In ACT 17, the processor 10 checks whether or not the change of the settings relating to the anchor region is requested. When the request cannot be checked, the processor 10 determines NO and proceeds to ACT 18.

In ACT 18, the processor 10 checks whether or not the setting end relating to the anchor region is requested. When the request cannot be checked, the processor 10 determines NO and returns to ACT 17.

Thus, in ACT 17 and ACT 18, the processor 10 waits for the change request or the end request.

When the setting change is requested from the computer terminal 3 as described above, the processor 10 determines YES in ACT 17 and proceeds to ACT 19.

In ACT 19, the processor 10 updates the anchor setting table TAB such that the notification in the change request is reflected. For example, when the change of the setting for whether to enable or disable the splitting function is instructed as described above, the processor 10 rewrites the field FBD with the designated setting. Next, the processor 10 returns to ACT 16 and repeats the subsequent processes as described above.

When it is not necessary to change the settings relating to the anchor region, the user may instruct the setting end through a predetermined operation on the anchor setting screen in the computer terminal 3. As a result, the computer terminal 3 requests the MFP 1 for the setting end. The processor 10 determines YES in ACT 18 in response to the request and returns to ACT 6 in FIG. 2.

When a new anchor region is designated after the processor 10 returns to ACT 6 from ACT 18, the processor 10 proceeds to ACT 15 in FIG. 3 from ACT 8 as described above. In this case, the processor 10 may generate a new anchor setting table TAB instead of the previously present anchor setting table TAB. Alternatively, the processor 10 may rewrite the field FBA of the previously present anchor setting table TAB with new designated coordinates. In addition, after returning to ACT 6 from ACT 18, the processor 10 may disallow the designation of a new anchor region. That is, the processor 10 receives a setting relating to only one anchor region. In this case, the processor 10 may maintain the anchor setting table TAB generated thus far as it is, and may generate a new anchor setting table TAB.

When all the settings relating to the recognition region and the anchor region end, the user may instruct the setting end through a predetermined operation on the region setting screen in the computer terminal 3. As a result, the computer terminal 3 notifies the setting end to the MFP 1. Accordingly, the processor 10 determines YES in ACT 9 in FIG. 2 and proceeds to ACT 20.

In ACT 20, the processor 10 generates a template file including the recognition setting table TAA and the anchor setting table TAB generated through the processes after ACT 6, and stores the generated template file in the template storage unit STA. Next, the processor 10 returns to the wait state of ACT 1 and ACT 2.

When a document is read using the zone OCR function, the user may instruct the recognition start through, for example, a predetermined operation in the operation and display unit 13. In accordance with the instruction, the processor 10 determines YES in ACT 2 and proceeds to ACT 21.

In ACT 21, the processor 10 causes the operation and display unit 13 to display a selection screen. The selection screen is a screen for allowing the user to select one template corresponding to each of the template files stored in the template storage unit STA.

In ACT 22, the processor 10 waits for designation of a template. When the template is designated through a predetermined operation by the user in the operation and display unit 13, the processor 10 determines YES and proceeds to ACT 23. Hereinafter, the template designated herein will be referred to as “applied template”.

In ACT 23, the processor 10 waits for an instruction to read a document.

After setting a document as a recognition target on the scanner unit 14, the user may instruct reading the document through, for example, a predetermined operation in the operation and display unit 13. In accordance with the instruction, the processor 10 determines YES in ACT 23 and proceeds to ACT 24.

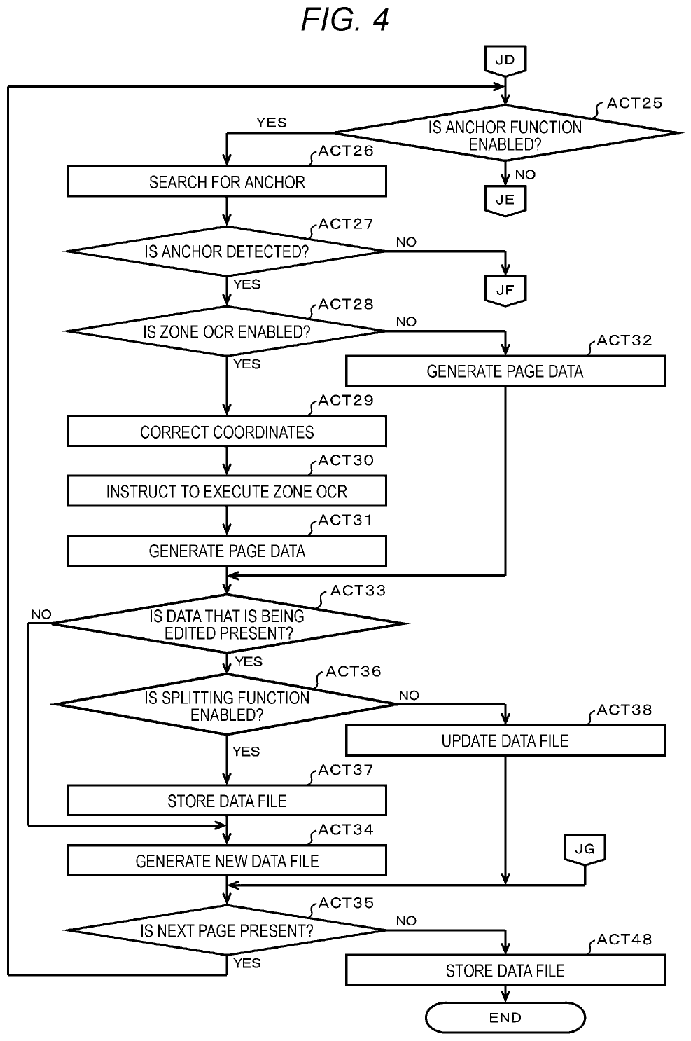

In ACT 24, the processor 10 takes in an image as a recognition target (hereinafter, referred to as “target image”). The processor 10 causes, for example, the scanner unit 14 to read a document and stores the obtained image in the main memory 11 or the auxiliary storage unit 12 as the target image. When a plurality of documents are present, each of images read from the documents by the scanner unit 14 is stored as the target image. Next, the processor 10 proceeds to ACT 25 in FIG. 4.

In ACT 25, the processor 10 checks whether or not the anchor function is enabled. For example, the processor 10 checks whether or not any one of “Enable” or “Disable” is set to the field FBC in the anchor setting table TAB in the applied template. When “Enable” is set, the processor 10 determines YES and proceeds to ACT 26.

In ACT 26, the processor 10 searches for the anchor from the target image. The processor 10 selects one image as a processing image in order of reading from the target image. The processor 10 searches for the anchor image from the processing image, the anchor image being set to the field FBB of the anchor setting table TAB in the applied template. For example, well-known template matching is applied to this search.

In ACT 27, the processor 10 checks whether or not the anchor can be detected. For example, when the anchor image is detected in the above-described search, the processor 10 determines YES and proceeds to ACT 28.

This way, the processor 10 confirms that the anchor image as the predetermined element image is included in the processing image. The processor 10 repeats this confirmation for each of a plurality of pages of read images as the processing image. Thus, by the processor 10 executing the information processing based on the zone OCR application APA, a computer including the processor 10 as a central part functions as the confirmation unit.

In ACT 28, the processor 10 checks whether or not the zone OCR is enabled. When the zone OCR is applied to the target image including the anchor image, the user may set the zone OCR to be enabled. For example, the processor 10 checks whether or not any one of “Enable” or “Disable” is set to the field FBE in the anchor setting table TAB in the applied template. When “Enable” is set, the processor 10 determines YES and proceeds to ACT 29.

In ACT 29, the processor 10 corrects coordinates in the recognition region to compensate for a difference between coordinates in the image for setting used for setting the applied template and the coordinates in the processing image. For example, the processor 10 acquires the amount of difference between the coordinates in the processing image and the coordinates in the image for setting as the amount of difference between coordinates of a region where the anchor image is detected in the processing image and the coordinates set to the field FBA of the anchor setting table TAB in the applied template, and changes, for example, the coordinates set to the field FAB of the recognition setting table TAA in the applied template such that the amount of difference decreases.

In ACT 30, the processor 10 instructs the recognition unit 17 to execute the zone OCR. For example, the processor 10 notifies the corrected coordinates and the recognition type set to the field FAD of the recognition setting table TAA in the applied template to the recognition unit 17, and the processor 10 instructs the recognition unit 17 to execute the recognition. When a plurality of recognition setting tables TAA are included in the applied template, the processor 10 notifies the recognition unit 17 of a set of the corrected coordinates and the recognition type regarding each of the recognition setting tables TAA.

When the recognition type designated in a region having the coordinates designated in the processing image is text, the recognition unit 17 recognizes the text, and when the designated recognition type is a barcode, the recognition unit 17 recognizes the barcode.

In this manner, by instructing the execution of the zone OCR, the processor 10 controls the recognition unit 17 as the recognition unit to recognize characters displayed in a recognition region determined relative to a region where the anchor image as the element image is formed. Thus, by the processor 10 executing the information processing based on the zone OCR application APA, a computer including the processor 10 as a central part functions as the control unit.

In ACT 31, the processor 10 generates page data on which the recognition result in the recognition unit 17 is reflected in a predetermined data format. For example, the processor 10 generates page data including, as a content, data in which text data having a transparent character color is attached to image data representing the processing image, the text data being obtained as the recognition result in the recognition unit 17.

On the other hand, when the zone OCR is disabled, the processor 10 determines No in ACT 28 and proceeds to ACT 32.

In ACT 32, the processor 10 generates page data not relating to the recognition result in the recognition unit 17 in a predetermined data format. For example, the processor 10 generates page data including, as a content, only the image data representing the processing image.

The processor 10 proceeds to ACT 33 from ACT 31 or ACT 32.

In ACT 33, the processor 10 checks whether or not a data file that is being edited is present. When the processing image is a target image relating to the first page, the data file that is being edited is not yet present. Accordingly, in this case, the processor 10 determines NO and proceeds to ACT 34.

In ACT 34, the processor 10 newly generates a data file including the page data generated in ACT 31 or ACT 32. This data file may be, for example, a multi-page type document file. It is assumed that the format of the data file is, for example, a portable document format (PDF). The processor 10 stores the data file generated herein in a region outside of the file storage unit STB of the main memory 11 or the auxiliary storage unit 12 as the data file that is being edited.

In ACT 35, the processor 10 checks whether or not a target image relating to the next page of a target image as the processing image is present. When the corresponding target image is present, the processor 10 determines YES, returns to ACT 25, changes the processing image to the target image relating to the next page, and executes the processes after ACT 25 as described above.

In a case where the second or subsequent page of the target image is the processing image, when the processor 10 proceeds to ACT 33, the data file that is previously generated as described above, and is being edited, is present. Therefore, in this case, the processor 10 determines YES in ACT 33 and proceeds to ACT 36.

In ACT 36, the processor 10 checks whether or not the splitting function is enabled. For example, the processor 10 checks whether or not any one of “Enable” or “Disable” is set to the field FBD in the anchor setting table TAB in the applied template. When “Enable” is set, the processor 10 determines YES and proceeds to ACT 37.

In ACT 37, the processor 10 stores the data file that is being processed at the present time in the file storage unit STB. Next, the processor 10 proceeds to ACT 34 and newly generates a data file including the page data generated in ACT 31 or ACT 32. That is, the processor 10 splits a data file relating to pages after a page where the anchor is detected as a different file from a data file relating to pages before the page where the anchor is detected.

FIG. 8 is a diagram illustrating a state of file splitting.

The upper side of FIG. 8 illustrates a reading document consisting of 6 pages. In this reading document, a first document consisting of 3 pages and a second document consisting of 3 pages overlap each other. The first pages of the first document and the second document include a common image IMA.

In this case, when the image IMA functions as the anchor and the splitting function is enabled, as illustrated on the lower side of FIG. 8, a data file DFA including the first to third pages and a data file DFB including the fourth to sixth pages are separately generated.

In this manner, the processor 10 causes a recognition result of each of pages to be included in a single data file, the pages ranging from a page that is confirmed to include the anchor image as the element image to a page just before the next page that is confirmed to include the anchor image. That is, the processor 10 generates a data file as a single file based on a recognition result of a page having a predetermined relationship with a page that is confirmed to include the anchor image as the element image. Thus, by the processor 10 executing the information processing based on the zone OCR application APA, a computer including the processor 10 as a central part functions as the generation unit.

When the splitting function is disabled, the processor 10 determines No in ACT 36 and proceeds to ACT 38.

In ACT 38, the processor 10 updates the data file that is being edited to include the page data generated in ACT 31 or ACT 32. That is, when the splitting function is disabled, the processor 10 also adds the page where the anchor is detected to the data file that is being edited.

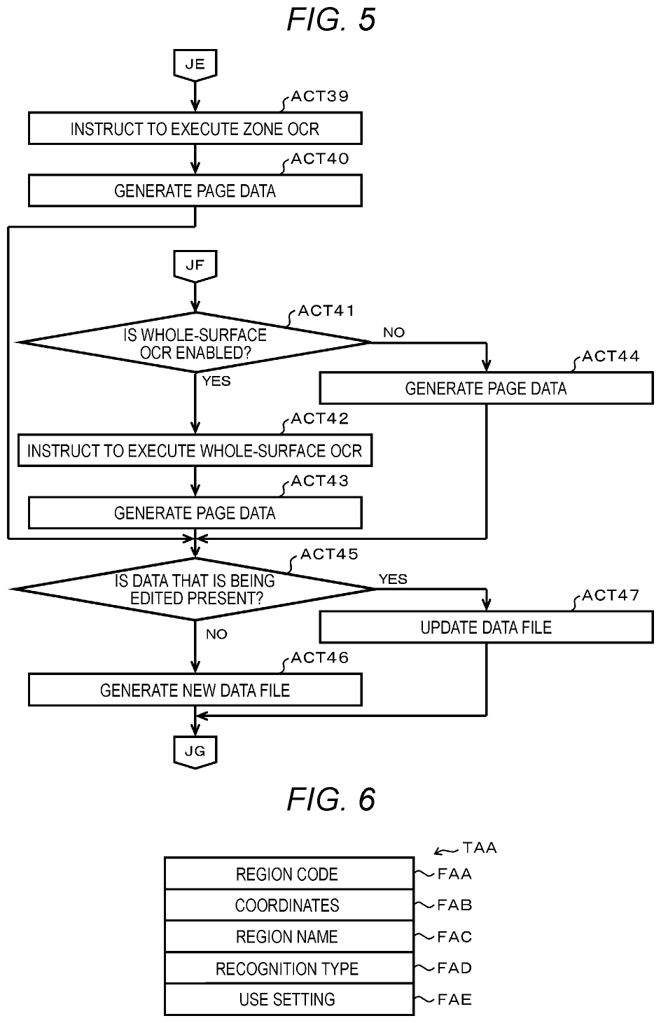

When the anchor function is disabled, the processor 10 determines NO in ACT 25 and proceeds to ACT 39 in FIG. 5.

In ACT 39, the processor 10 instructs the recognition unit 17 to execute the zone OCR. For example, the processor 10 notifies the recognition unit 17 of the coordinates and the recognition type set to the fields FAB and FAD of the recognition setting table TAA in the applied template, and instructs the recognition unit 17 to execute the recognition. When a plurality of recognition setting tables TAA are included in the applied template, the processor 10 notifies the recognition unit 17 of a set of the coordinates and the recognition type regarding each of the recognition setting tables TAA. At this time, the notified coordinates are set to the recognition setting table TAA as described above and are not corrected.

When the recognition type designated in a region having the coordinates designated in the processing image is a text, the recognition unit 17 recognizes the text, and when the designated recognition type is a barcode, the recognition unit 17 recognizes the barcode.

In ACT 40, the processor 10 generates page data on which the recognition result in the recognition unit 17 is reflected in a predetermined data format. For example, the processor 10 generates page data including, as a content, data in which text data having a transparent character color is attached to image data representing the processing image, the text data being obtained as the recognition result in the recognition unit 17.

On the other hand, when the anchor function is enabled and the anchor cannot be detected from the processing image, the processor 10 determines NO in ACT 27 in FIG. 4 and proceeds to ACT 41 in FIG. 5.

In ACT 41, the processor 10 checks whether or not the whole-surface OCR is enabled. When the user wants to cause the page not including the anchor to be recognized, the user enables the whole-surface OCR. For example, the processor 10 checks whether or not any one of “Enable” or “Disable” is set to the field FBF in the anchor setting table TAB in the applied template. When “Enable” is set, the processor 10 determines YES and proceeds to ACT 42.

In ACT 42, the processor 10 instructs the recognition unit 17 to execute the whole-surface OCR.

When the whole-surface OCR is instructed, the recognition unit 17 recognizes a text regarding the whole region of the processing image. The whole region is determined as a region that is determined in the processing image in a fixed manner, for example, as a region excluding a part of the periphery of the processing image. The whole region is a region not relating to the region where the anchor is formed.

In ACT 43, the processor 10 generates page data on which the recognition result in the recognition unit 17 is reflected in a predetermined data format. For example, the processor 10 generates page data including, as a content, data in which text data having a transparent character color is attached to image data representing the processing image, the text data being obtained as the recognition result in the recognition unit 17.

When the whole-surface OCR is disabled, the processor 10 determines No in ACT 41 and proceeds to ACT 44.

In ACT 44, the processor 10 generates page data not relating to the recognition result in the recognition unit 17 in a predetermined data format. For example, the processor 10 generates page data including, as a content, only the image data representing the processing image.

When the generation of the page data in ACT 40, ACT 43, or ACT 44 ends, the processor 10 proceeds to ACT 45 in either case.

In ACT 45, the processor 10 checks whether or not a data file that is being edited is present. When the processing image is a target image relating to the first page, the data file that is being edited is not yet present. Accordingly, in this case, the processor 10 determines NO and proceeds to ACT 46.

In ACT 46, the processor 10 newly generates a data file including the page data generated in ACT 40, ACT 43, or ACT 44 as the data file that is being edited.

In addition, when the data file that is being edited is present, the processor 10 determines YES in ACT 45 and proceeds to ACT 47.

In ACT 47, the processor 10 updates the data file that is being edited to include the page data generated in ACT 40, ACT 43, or ACT 44. That is, the processor 10 adds new page data to the data file that is being edited.

When ACT 46 or ACT 47 ends, the processor 10 proceeds to ACT 35 in FIG. 4 and executes the subsequent processes as described above.

In a case where the above-described processes end for a target image relating to the final page as the processing image, when the processor 10 proceeds to ACT 35, the processor 10 determines NO in ACT 35 and proceeds to ACT 48.

In ACT 48, the processor 10 stores the data file that is being edited in the file storage unit STB. In a case where the data file is stored in the file storage unit STB in ACT 48 or ACT 37, when “Make Folder Name” is set to the field FAE of the recognition setting table TAA in the applied template, the processor 10 stores the data file in a folder having a folder name determined using the result of character recognition in accordance with a predetermined rule. In addition, when “Make File Name” is set to the field FAE, the processor 10 stores the data file as a data file having a file name determined using the result of character recognition in accordance with a predetermined rule. In addition, when “Do Not Use” is set to the field FAE, the processor 10 applies a folder name and a file name determined in accordance with a predetermined rule irrespective of the result of character recognition. The processor 10 ends the zone OCR process.

As described above, the MFP 1 operates in various ways in accordance with the settings and, in one example, operates as follows. The MFP 1 collectively reads a document group in which a plurality of documents consisting of a plurality of pages overlap each other, the documents including the anchor as a common image in the first pages. Regarding at least a part of the pages, the MFP 1 recognizes characters displayed in the recognition region relative to the region where the anchor is formed. The MFP 1 splits the recognition result into a plurality of data files that include the pages including the common image as the first pages, respectively. Thus, the MFP 1 splits the recognition result into a plurality of data files that share the anchor for determining the recognition region, the anchor being various images such as company logos that can be displayed on the first pages. As a result, the function of splitting the result of character recognition to generate a plurality of data files can be more easily used.

In addition, the MFP 1 causes the recognition result of each of pages to be included in a single data file, the pages ranging from a page where the anchor is detected to a page just before the next page where the anchor image is detected. Therefore, the MFP 1 can generate a plurality of data files into which the recognition result is split for each document while collectively reading a plurality of documents that consist of a plurality of pages and overlap each other, the first pages of the documents including the common image at a common position.

In the MFP 1, when the splitting function is enabled, the splitting form of the data files is determined based on the page including the anchor. Therefore, pages not including the anchor are included in the reading document. When character recognition is executed on the pages not including the anchor, the MFP 1 sets the whole region of the pages as the recognition region. As a result, even when the recognition region cannot be specified as the region determined relative to the region where the anchor is formed, the character recognition can be executed.

When the MFP 1 is used, a case can be considered where the page including the anchor as a mark for file splitting is included in the reading document. There may be a case where this page does not include a content as a target of character recognition. When the zone OCR is disabled, the MFP 1 does not execute character recognition on the page including the anchor. Therefore, in the above-described cases, the processing time can be reduced without executing an unnecessary recognition process.

This embodiment can be modified as follows in various ways.

After correcting the coordinates in ACT 29 in FIG. 4, the processor 10 may also execute the zone OCR on the processing image where the anchor is not detected based on the corrected coordinates.

The processor 10 may execute the whole-surface OCR on the processing image where the anchor is detected.

The processor 10 may generate a single data file that collectively includes the page data regarding the processing image where the anchor is detected in addition to or instead of the operations of the embodiment. As a result, for example, a digest document that collectively includes the first pages of a plurality of documents can be generated. That is, the relationship between the page where the anchor is detected and a page of which the recognition result is stored as a single data file can be freely determined and, for example, may be appropriately set by, for example, a designer of the MFP 1, a manager of the MFP 1, a user, or the like.

The processor 10 may generate a data file not including the image data representing the processing image. In addition, the processor 10 may generate a data file including given data different from the image data representing the recognition result and the processing image.

The recognition process that is executed by the recognition unit 17 may be executed by the processor 10.

In the above-described embodiment, the instruction that is received by the computer terminal 3 may be received by the operation and display unit 13. In addition, the instruction that is received by the operation and display unit 13 may be received by the computer terminal 3.

At least one embodiment can also be implemented as an image processing apparatus that executes processing on image data obtained in another reading apparatus or image data transmitted from another information processing apparatus.

A part or all of the respective functions that are implemented by the processor 10 through the information processing can also be implemented by hardware that executes information processing not based on a program, for example, a logic circuit. In addition, each of the respective functions can also be implemented by a combination of the hardware such as a logic circuit and a software control.

While certain embodiments have been described these embodiments have been presented by way of example only, and are not intended to limit the scope of the disclosure. Indeed, the novel embodiments described herein may be embodied in a variety of other forms: furthermore various omissions, substitutions and changes in the form of the embodiments described herein may be made without departing from the spirit of the disclosure. The accompanying claims and their equivalents are intended to cover such embodiments or modifications as would fall within the scope and spirit of the disclosure.

What is claimed is:

1. An image processing apparatus comprising:
a recognition processor configured to recognize characters displayed on an image;
a confirmation processor configured to confirm that a predetermined element image is included in each of a plurality of pages of read images;
a controller configured to control the recognition processor to recognize characters displayed in a recognition region, the recognition region determined relative to a region where the element image is formed; and
a generation processor configured to generate a data file as a single file based on a recognition result of a page by the recognition processor, the page having a predetermined relationship with a page of the read image that is confirmed to include the element image by the confirmation processor.

2. The apparatus according to claim 1,
wherein the generation processor is configured to generate the data file as a single file based on a recognition result of each of pages by the recognition processor, the pages ranging from a page of the read image, that is confirmed to include the element image by the confirmation processor, to a page just before a next page of the read image that is confirmed to include the element image by the confirmation processor.

3. The apparatus according to claim 1,
wherein the controller is configured to control the recognition processor to recognize characters displayed in a region, which is predetermined irrespective of the region where the element image is formed, regarding the read image that is not confirmed to include the element image by the confirmation processor.

4. The apparatus according to claim 1, wherein the processors and controller are implemented by at least one of hardware or software.

5. The apparatus according to claim 1, wherein the processors and controller are implemented by at least one processor.

6. The apparatus according to claim 1, wherein the processors and controller are implemented by one processor.

7. The apparatus according to claim 1, wherein the recognition processor is configured to recognize the characters via zone optical character recognition (OCR).

8. The apparatus according to claim 1, further comprising a scanner configured to create an image including characters recognized by the recognition processor.

9. The apparatus according to claim 3, further comprising a display configured to display a region setting screen.

10. The apparatus according to claim 3, wherein the controller is configured to generate a recognition setting table including recognized regions.

11. A method causing a computer, that is included in a recognition processor being configured to recognize characters displayed on an image and an image processing apparatus, to execute functions comprising:
confirming that a predetermined element image is included in each of a plurality of pages of read images;
controlling the recognition processor to recognize characters displayed in a recognition region, the recognition region determined relative to a region where the element image is formed; and
generating a data file as a single file based on a recognition result of a page by the recognition processor, the page having a predetermined relationship with a page of the read image that is confirmed by the confirmation processor to include the element image.

12. The method according to claim 11, wherein the functions further comprise:
generating the data file as a single file based on a recognition result of each of pages by the recognition processor, the pages ranging from a page of the read image, that is confirmed to include the element image, to a page just before a next page of the read image that is confirmed to include the element image that is confirmed.

13. The method according to claim 11, wherein the functions further comprise:
controlling the recognition processor to recognize characters displayed in a region, which is predetermined irrespective of the region where the element image is formed, regarding the read image that is not confirmed to include the element image by the confirmation.
